(19) United States
(12) Patent Application Publication
(10) Pub. No.: US 2003/0215560 A1
(43) Pub. Date: Nov. 20, 2003

(54) Labiatae herb extract compositions readily dispersible in cold brine

(76) Inventors: Paul H. Todd JR., Kalamazoo, MI (US); P. Douglas Williams, Kalamazoo, MI (US); Gregory S. Reynhout, Kalamazoo, MI (US); Polly A. Walter, Kalamazoo, MI (US)

Correspondence Address: FLYNN THIEL BOUTELL & TANIS, P.C., 2026 RAMBLING ROAD, KALAMAZOO, MI, 49008-1699, US

(21) Appl. No.: 10/409,038

(22) Filed: Apr. 8, 2003

Related U.S. Application Data
(60) Provisional application No. 60/370,850, filed on Apr. 8, 2002.

(51) Int. Cl. A23L 1/221

(52) U.S. Cl. 426/650; 426/655

(57) ABSTRACT

A single phase, emulsifiable composition consisting essentially of a Labiatae herb extract, a food grade emulsifier or mixtures of food grade emulsifiers and a diluent selected from the group consisting of benzyl alcohol, propylene glycol, ethanol and mixtures thereof. Also provided is a stable cold Labiatae herb extract brine dispersion comprising the composition and a 5% brine solution.

### CROSS-REFERENCE TO RELATED APPLICATION

This application claims the benefit of U.S. provisional application Serial No. 60/370 850, filed Apr. 8, 2002 under 35 US 119(e)(i), which is incorporated herein by reference.

### FIELD OF INVENTION

This invention relates to compositions and processes useful for preparing brine dispersions of rosemary and other Labiatae herb extracts.

### BACKGROUND OF INVENTION

Because of rosemary extract's outstanding ability to preserve fresh meat flavor and color, it has found considerable use in the meat and poultry industries. Rosemary extract has been added directly to fresh ground meat and poultry. Among the other Labiatae extracts, sage is also preferred and most similar to rosemary.

Rosemary extracts have also been spray applied in neat form or added as dispersions in water or brine solutions.

Brine solutions containing rosemary extract have also been injected into whole muscle meat and poultry. This invention addresses a problem encountered in preparing brine dispersions of rosemary, sage and other Labiatae herb extracts.

There are two basic kinds of rosemary extracts, oil soluble and water-soluble. Both are used in the meat industry in various applications. They differ in the chemical structure of the phenolic compounds, which give them their antioxidant properties, and in the chemical characteristics of the non-antioxidant constituents. Oil soluble rosemary extracts contain a number of sesquiterpene phenolics, the most important of which are carnosic acid and carnosol. Water-soluble rosemary extracts contain other phenolic compounds, the most important of these being rosmarinic acid. Oil soluble rosemary extracts can be formulated to disperse in water by adding sufficient amounts of emulsifiers or mixtures of emulsifiers For use in meat and poultry, these emulsifiers must be approved for food use. Such compositions, when added to water, form emulsions that suffer from two major problems. The first problem deals with the amount of energy, in the form of agitation, which is required to produce the emulsion. The second problem relates to the stability of the emulsion, once formed, over time. Both of these problems are made worse if the emulsions need to be formed at low temperatures and/or in brine solutions as opposed to water. Both of these requirements are standard operating conditions in meat and poultry processing plants.

The meat industry suffers serious economic consequences if brine preparation becomes problematic or rosemary dispersions in brine fail to hold together for the required amount of time. The former problem may require significant capital expenses through the addition of more capable agitation systems or lengthened, productivity-reducing agitation cycles. The second problem can cause production delays due to plugged sprayers or injectors and lead to increased clean-up costs and product losses.

Information Disclosure

U.S. Pat. No. 6,514,551 describes a method for improving the keeping quality of microbially perishable products wherein the surface of the product or surfaces the product comes into contact with are treated with a processing aid which comprises benzyl alcohol and at least one microbicidally active GRAS (generally regarded as safe) flavoring agent, including alcoholic, glycolic or supercritical carbon dioxide extracts of rosemary. In one of the claims, the method is stated to be intended for brushing, spreading, emulsifying, separating, cleaning, spraying, nebulizing, volatizing and cutting. The specification mentions a limited number of emulsifying agents such as lecithins and citric acid monoglycerides.

T. L. Barr and S. D. Holt, U.S. Patent Application No. 20010011083, describes a composition containing capsaicin for treating pain that contains other ingredients which neutralize the discomfort from the capsaicin. The composition comprises a topical carrier; a transdermal component selected from a group comprising rosemary extract, benzyl alcohol, (among other things) and combinations thereof; an encapsulating agent; a solubility agent; a viscosity adjusting agent; and an analgesic agent. In another claim, a skin and tissue emollient is also added to the above, and includes propylene glycol. The topical carriers are selected from a group comprising: aqueous carriers, oil based carriers, fat based carriers and fatty alcohol based carriers, water or combinations thereof. The inventors also claim an ingestible composition, which includes hops. In the specification, hydrogenated lecithin is described as one of the effective encapsulating agents. It is also described as an emulsifier. Also, in the specification, the inventors contemplate addition of propylene glycol with methyl and propyl parabens as stabilizers.

R. J. Evans and G. S. Reynhout (U.S. Pat. No. 6,010,726) describe a method for electrostatically coating foodstuffs with base liquid oils and fats containing organic diluents (including benzyl alcohol and propylene glycol) and a flavoring (including rosemary extract). The patent describes commercial Herbalox® Seasoning compositions which contain rosemary extracts in combination with hydroxylated lecithin and Panodane or with Polysorbate-80. In Example 11, the electrostatic properties of a composition of coconut oil, rosemary extract, benzyl alcohol or propylene glycol or lecithin are described.

Todd, Jr. et al (U.S. Pat. No. 5,209,870) describes a method for preparing a lipid-free rosemary extract by partitioning rosemary oleoresin into an alkaline, aqueous lower-aliphatic alcoholic or polyol solution. Rosemary extract, polyethylene glycol and polyglycerol ester or sugar ester (emulsifiers) mixtures are described

Todd, Jr. (U.S. Pat. No. 6,099,879) describes the use of rosemary extract to prevent off-flavor formation in irradiated foods. Combinations of rosemary extract, lecithins, mono and diglycerides, diacetyltartaric acid esters of mono and diglycerides and sorbitan esters are described. Rosemary extracts or the active phenolic components dispersed or dissolved in propylene glycol are mentioned.

King (WO 96/16140) discloses a translucent antioxidant solution comprising carnosic acid (from rosemary), a distilled monoglyceride and propylene glycol. Carnosic acid levels as low as 5-6 percent (approaching those for commercial rosemary extracts) are claimed.

Oppenheim, et al (WO 99/20289) discloses a clear herbal extract solution (including rosemary extract) suitable for encapsulation that includes propylene glycol and a medium chain triglyceride.

Kreuter, et al (U.S. Pat. No. 6,207,164) discloses a process for extracting plant material wherein a solvent is mixed with an agent. The solvent is later removed and the agent provides a number of beneficial effects. The agents claimed include propylene glycol and polyethylene glycol. Rosemary is one of the plant materials claimed.

Chimento (U.S. Pat. No. 5,270,035) describes a hair conditioner composition consisting essentially of water, disodium cocoamphodiacetate, and at least one of inositol, a surfactant and a natural herb extract. Polysorbate-80 is present in the claims, as is rosemary extract and propylene glycol as a carrier.

As an advance over the prior art, we have found that the ease with which Labiatae herb extract/emulsifier combinations can be dispersed into cold brine solutions can be greatly enhanced by including a diluent such as benzyl alcohol, propylene glycol, ethanol or mixtures thereof into the combination. None of the prior art teaches compositions that are readily dispersible in cold brines and that form a dispersion in cold brine that is itself stable for at least 30 minutes. This invention makes the use of Labiatae herb extracts in meat processing facilities much more practical.

### OBJECTS OF THE INVENTION

An object of the present invention is to provide a Labiatae herb extract composition which is more easily dispersible in cold brine solutions, such as those used in the meat and poultry industries, for injecting into meat and poultry.

Another object of the invention is to provide a method for preparing such a composition.

A further object of the invention is to provide novel Labiatae herb/brine dispersions.

A further object of the invention is to provide a method for preparing Labiatae herb extract/brine dispersions using the inventive compositions of this invention.

A still further object of the invention is to provide compositions, cold brine dispersions and methods for making them that solves a processing problem in the meat and poultry industry where ease of dispersing and stability of the resulting brine dispersion are critical performance issues.

Other objects of the invention are to provide compositions that, in addition to being readily brine dispersible, provide brine dispersions that are extremely stable when compared to typical compositions known to the art and that minimize clogging of brine-handling machinery.

### SUMMARY OF INVENTION

We have found that the ease with which Labia tae herb extract/emulsifier combinations can be dispersed into cold brine solutions can be greatly improved by including a diluent such as benzyl alcohol, propylene glycol, ethanol or mixtures thereof into the combination. This invention makes the use of Labiatae herb extracts in meat and poultry processing facilities much more practical. Our invention provides singly or in combination:

A single phase, emulsifiable composition consisting essentially of a Labiatae herb extract, a food grade emulsifier or mixtures of food grade emulsifiers and a diluent selected from the group consisting of benzyl alcohol, propylene glycol, ethanol and mixtures thereof.

A composition consisting essentially of about 5% to about 30% by weight of Labiatae herb extract, about 7% to about 77% by weight of benzyl alcohol by weight, about 9% to about 77% oleyl lactylic acid by weight and 0% to about 60% by weight of propylene glycol.

A composition as described above wherein the Labiatae herb extract is rosemary herb extract.

A composition as described above wherein the Labiatae herb extract is sage herb extract.

A preferred composition consisting of about 16% by weight of rosemary herb extract, about 15% by weight of benzyl alcohol by weight, about 54% oleyl lactylic acid by weight and about 15% by weight of propylene glycol.

A composition, as described above, consisting essentially of Labiatae herb extract, oleyl lactylic acid and benzyl alcohol, which is readily dispersible in cold brine of about 5% concentration of salts.

A single phase, emulsifiable composition consisting essentially of a Labiatae herb extract, a food grade emulsifier or mixture of food grade emulsifiers, a diluent selected from the group consisting of benzyl alcohol, propylene glycol, ethanol and mixtures thereof, a food enhancer selected from the group consisting of a flavoring agent, an antimicrobial agent and a coloring agent.

A composition, as described above, that contains other adjuvants and vegetable oils including canola oil, soy oil, cottonseed oil, peanut oil, coconut oil and medium chain triglycerides (caprylic and caproic triglycerides).

A composition as described above, wherein the viscosity of the composition does not exceed 1000 centipoises at 25.4° C.

A stable cold Labiatae herb extract brine dispersion comprising a Labiatae herb extract, a food grade emulsifier or a mixture of food grade emulsifiers, a diluent selected from the group consisting of benzyl alcohol, propylene glycol, ethanol and mixtures thereof and a 5% brine solution.

A stable cold Labiatae herb brine dispersion as described above, wherein the Labiatae herb extract is rosemary, the food grade emulsifier is oleyl lactylic acid and the diluent is benzyl alcohol.

A stable cold Labiatae herb brine dispersion as described above, wherein the Labiatae herb extract is rosemary, the food grade emulsifier is oleyl lactylic acid and the diluent is propylene glycol.

A cold Labiatae herb brine dispersion as described above, wherein the Labiatae herb extract is rosemary, the food grade emulsifier is oleyl lactylic acid and the diluent is a mixture of benzyl alcohol and propylene glycol.

A method of preparing a stable cold brine dispersion as defined above, which comprises adding a Labiatae herb extract, a food grade emulsifier and diluent selected from the group consisting of benzyl alcohol, propylene glycol, ethanol and mixtures thereof to a cold salt or cold phosphate solution. Oleyl lactylic acid, which adds dramatic stability to the cold brine, is the preferred food grade emulsifier. As it greatly improves the Labiatae herb extract dispersion in the brine, benzyl alcohol is the preferred diluent.

The Labiatae herb/cold brine dispersion can be prepared by introducing the Labiatae herb extract, emulsifier and diluent together into the brine in the form of the novel composition of this invention.

Other food enhancing agents can be added to the compositions of this invention. Hence the invention further provides:

A single phase, emulsifiable composition consisting essentially of a Labiatae herb extract, a food grade emulsifier or mixture of food grade emulsifiers, a diluent selected from the group consisting of benzyl alcohol, propylene glycol, ethanol and mixtures thereof, and a food enhancing agent selected from the group consisting of flavoring agents, antimicrobial agents and coloring agents.

### DETAILED DESCRIPTION OF THE INVENTION

The present invention provides compositions comprising Labiatae herb extracts, a food grade emulsifier or mixture of food grade emulsifiers and a diluent selected form the group consisting of benzyl alcohol, propylene glycol, ethanol and mixtures thereof to prepare stable cold brine dispersions that are useful in the processing of meat and poultry.

Before proceeding further with a description of the preferred embodiments of the invention. A number of terms will be defined.

Definitions

As used herein:

“Brine solution” means an aqueous solution of sodium or potassium chloride salts, sodium or potassium polyphosphate salts or mixtures thereof.

“Food enhancing agents” mean food flavoring agents such as black pepper oleoresin, celery oleoresin, cumin oleoresin and mixtures thereof; essential oils such as onion oil, garlic oil, black pepper oil, celery oil and mixtures thereof; plant extracts such as bay extract, black pepper extract, capsicum extract, celery extract, clove extract, cumin extract, garlic extract, onion extract, licorice extract, thyme extract, oregano extract, white pepper extract and mixtures thereof, and butter flavoring; anti-microbial agents such as acetates, diacetates and acidulants, i.e. citric acid and ascorbic acid; coloring agents such as anthocyanin pigments, paprika oleoresin, turmeric extract and caramel colors.

“Labiatae herb extract” means extract from plants of the Labiatae genus, preferably rosemary, sage, oregano, thyme, mint and mixtures thereof.

“meat” means entire carcasses, cut portions thereof, and ground or chopped portions thereof of cattle, swine, sheep, goats, bison, buffalo, elk and deer.

“poultry” means entire carcasses, cut portions thereof, and ground or chopped portions thereof of chickens, turkeys, ducks, geese, and guinea fowl.

“stable Labiatae herb extract/cold brine dispersion” means a Labiatae herb extract/cold brine dispersion that is extremely stable when compared to typical prior art Labiatae herb extract/brine dispersions and from which the Labiatae herb extract composition will not float out prior to 30 minutes after the dispersion is formed.

“Temperatures” are in degrees Centigrade.

“wt %” means the weight percent based upon total weight.

The starting materials for preparing the compositions and brine dispersions of this invention are either commercially available or can be readily prepared by methods well known in the art.

Starting Materials

Labiatae Herb Extracts

Rosemary herb extracts can be prepared by extracting rosemary with food grade solvents or with supercritical carbon dioxide. Extracts consisting largely of lipophillic components contain carnosic acid, carnosol and other phenolic constituents. The amount of carnosic acid in the extract can range from 0.5 to 50% or more. Carnosol contents can range from 0.1 to 10% or more. Extracts consisting largely of hydrophillic substances contain rosmarinic acid. Rosmarinic acid content can range from 0.1 to 35% or more, however, these concentrations in the extract are not considered limiting. Extracts made using solvents of intermediate polarity contain both the lipophillic and hydrophillic components. Carriers, such as vegetable oil, emulsifiers, propylene glycol, edible solvents and other adjuvants can be used in the compositions. Herbalox® Seasoning is a registered trademark of Kalsec, Inc.

Extracts from oregano, sage, thyme and mint can be prepared utilizing methods well known in the art, including those described above for preparing rosemary extracts.

The Labiatae herb extracts used in the present invention can be either in the form of lipophillic and hydrophillic preparations alone or mixtures thereof.

Diluents

The diluents used in this invention, are benzyl alcohol, propylene glycol, ethanol and mixtures thereof. The preferred diluent is benzyl alcohol.

Emulsifiers

Food-grade emulsifiers or combinations of food grade emulsifiers that will function in this invention are listed below.

Emulsifiers Based on Mono- and Diglyceridees of Fatty Acids

Mono- and Diglycerides

glycerol

glycerol monooleate in propylene glycol

mono- and diglycerides—ethoxylated

ethoxylated glycerol monostearate

ethoxylated mono- and diglycerides

mono- and diglycerides—acetylated

acetylated monoglycerides

polyglycerol esters

decaglycerol monocaprylate/caproate decaglycerol tetraoleate

other polyglycerol poly fatty acid esters

mixed fatty and hydroxy-acid esters of glycerol

lactic acid esters of monoglycerides

succinic acid esters of monoglycerides

mixed fatty and hydroxy-acid esters of glycerol—acetylated

diacetylated tartaric acid esters of monoglycerides

Emulsifiers Based Upon Non-Glycerol Esters of Fatty Acids

fatty acids, ethoxylated

polyoxyethylene stearates

fatty acid esters of propylene glycol

propylene glycol esters of fatty acids

fatty acid esters of sorbitan and ethoxylated sorbitan (polysorbates)

Polysorbate-20

Polysorbate-80 (polyethylene oxide sorbitan monooleate)

fatty acid esters of sucrose

sucrose mono- and di-stearates

fatty acid esters of lactic acid

oleyl lactylic acid

Miscellaneous Food Approved Esters

esters of sulfosuccinic acid

dioctyl sulfosuccinate

Preferred emulsifiers are Polysorbate-80 and oleyl lactylic acid.

### PREPARATIONS AND EXAMPLES

Preparation 1—Brine

To water (93.40 grams, deionized) cooled to 0° to 2° C. in a container equipped for magnetic stirring was added slowly, with stirring, sodium phosphates (3.73 grams, a blend of sodium tripolyphosphate and sodium polyphosphate, glassy, Brifisol 512, BK Giulini Corporation) and sodium chloride (1.87 grams). The resulting brine solutions were kept cold. Addition of 1.0 grams of rosemary extract compositions resulted in 1% rosemary extract/brine dispersions.

### Example 1

Rosemary/Polysorbate-80 Composition

Rosemary extract (14.04 grams, Kalsec 41-000-23, Lot 8940W) was weighed into a 4-ounce glass container. Polysorbate 80 (32.36 grams, Glycosperse 020 X KFG, Lonza) and benzyl alcohol (3.6 grams, 99+% pure, Aldrich Inc.) were added. The resulting composition was heated to 35° C. for 15 min, with constant stirring. Other compositions were made in a similar manner, but varying the relative ratio of benzyl alcohol to polysorbate 80. Compositions utilizing oregano, sage, thyme mint Extracts and mixtures thereof can be prepared by combining the appropriate Labiatae herb extract or extracts as is described above for compositions containing rosemary extracts.

### Example 2

Rosemary/Oleyl Lactylic Acid Composition

Rosemary extract (8 gm) was combined with Benzyl alcohol (7.5 gm), Oleyl lactylic acid (27 gm) and Propylene glycol (7.5 gm). The resultant mixture was heated with stirring to approximately 50° C. and allowed to cool to room temperature. The final composition of this composition was:

| | |
|---|---|
| Rosemary extract | 16% |
| Benzyl alcohol | 15% |
| Oleyl lactylic acid | 54% |
| Propylene glycol | 15% |

### Example 3

Rosemary Extract Composition

The following composition was prepared and showed excellent uniformity, ease of dispersibility into brine solutions and excellent stability of the cold brine dispersion.

| | |
|---|---|
| Rosemary extract | 25% |
| Oleyl lactylic acid | 20% |
| Benzyl alcohol | 15% |
| Polysorbate-80 | 40% |

### Example 4

Savory Butter Seasoning Composition

The following composition was prepared and showed excellent uniformity, ease of dispersibility into brine solutions and excellent stability of the cold brine dispersion.

| | |
|---|---|
| Polysorbate-80 | 43% |
| Oleyl lactylic acid | 21% |
| Butter flavor | 13.35% |
| Benzyl alcohol | 9% |
| Other flavors | 7% |
| garlic extract | |
| onion extract | |
| black pepper extract | |
| celery extract | |
| Canola oil | 4.25% |
| Glycerine | 2.25% |
| Silicone antifoam | 0.15% |

### Example 5

Herb Seasoning Composition

The following composition was prepared and showed excellent uniformity, ease of dispersibility into brine solutions and excellent stability of the cold brine dispersion.

| | |
|---|---|
| Propylene glycol | 24% |
| Polysorbate-80 | 24% |
| Other flavors | 20% |
| garlic extract | |
| bay extract | |
| thyme extract | |
| cumin extract | |
| onion extract | |
| black pepper extract | |
| oregano extract | |
| clove extract | |
| Canola oil | 13% |
| Glycerine | 9.5% |
| Oleyl Lactylic acid | 8.5% |
| Silicone antifoam | 1.0% |

### Example 6

Cajun Seasoning Composition

The following composition was prepared and showed excellent uniformity, ease of dispersibility into brine solutions and excellent stability of the cold brine dispersion.

| | |
|---|---|
| Polysorbate-80 | 44.43% |
| Oleyl lactylic acid | 22% |
| Benzyl alcohol | 9.5% |
| Flavors | 7% |
| capsicum extract | |
| garlic extract | |
| black pepper extract | |
| white pepper extract | |
| onion extract | |
| rosemary extract | |
| Soybean oil | 4% |
| Diacetyltartaric acid esters | 4% |
| of mono and diglycerides | |
| Canola Oil | 4% |
| Propylene glycol | 3% |
| Hydroxylated lecithin | 3% |
| Silicone antifoam | 0.7% |

Compositions utilizing oregano, sage, thyme mint extracts and mixtures thereof can be prepared by combining the appropriate Labiatae herb extract or extracts as is described above for compositions containing rosemary extracts.

Testing the Ease of Dispersing Rosemary/Polysorbate-80 Compositions

Into four ounce, glass jars containing cold brine solution (99 grams) was added rosemary extract (1.0 gram), drop wise without agitation. The jars were capped and then carefully inverted and re-inverted to mix the ingredients—with one inversion and re-inversion counted as one shake. The number of shakes required to disperse each rosemary composition was determined and recorded.

Testing the Ease of Dispersing Rosemary/Oleyl Lactylic Acid Compositions

The oleoresin from Example 2 was tested for ease of dispersion using the formerly mentioned brine solution. To a four-ounce glass jar containing the cold brine solution (99 g) was added the oleoresin composition (1.0 gram), drop wise without agitation. The jar was capped and then carefully inverted and re-inverted to mix the ingredients—with one inversion and re-inversion counted as one shake. Two shakes were required to disperse the composition. The brine dispersion from this composition remained stable for over 2 week's time. This composition is the most preferred form of the present invention.

### Comparative Example

Roast Beef Seasoning.

Two flavor compositions were developed as a roast beef seasoning. The flavoring components consisted of garlic, fried garlic, onion, celery, black pepper and rosemary extracts. This combination of ingredients was then compounded at an 18% level in the following two compositions.

| Ingredients | Composition 1 | Composition 2 |
|---|---|---|
| Flavor Ingredients | 18% | 18% |
| Polysorbate-80 | 38% | 30.35% |
| Oleyl Lactylic Acid | 19% | 0 |
| Propylene Glycol | 0% | 30.35% |
| Canola Oil | 12% | 12% |
| Benzyl Alcohol | 8% | 0% |
| Glycerine | 4.7% | 5% |
| Diacetyltartaric | 0% | 4% |
| acid esters of mono | | |
| and diglycerides | | |
| Silicone Antifoam | 0.3% | 0.3% |

Composition 1 was a single-phase mixture, which did not separate on standing unstirred for 24 hours. Composition 2 separated into two distinct layers upon standing unstirred for 24 hours. Composition 1 dispersed in cold brine showed better stability than Composition 2 dispersed in brine.

Related compositions containing the following ranges of ingredients were also prepared:

16% rosemary extract

7 to 77% benzyl alcohol

9 to 77% oleyl lactylic acid

0 to 60% propylene glycol.

Each of these compositions showed superior dispersibility in brine, requiring less than five shakes to be readily dispersed.

The inventive compositions are clearly more readily and easily dispersed in room temperature and cold brines (and in water) as measured by the amount of agitation required to make a good dispersion. Compositions utilizing combinations of two or more emulsifiers in place of a single emulsifier can be used as described above.

It is to be understood that the invention is not to be limited to the exact details of operations, or compositions, methods, procedures, or embodiments shown an described, as obvious modifications and equivalents ill be apparent to one skilled in the art, and the invention is therefore to be limited only by the full scope which can be legally accorded to the claims hereof.

What is claimed is:

1. A single phase, emulsifiable composition consisting essentially of a Labiatae herb extract, a food grade emulsifier or mixture of food grade emulsifiers, a diluent selected from the group consisting of benzyl alcohol, propylene glycol, ethanol and mixtures thereof.

2. A composition according to claim 1, wherein the Labiatae herb extract is rosemary herb extract.

3. A composition according to claim 1, wherein the Labiatae herb extract is sage herb extract.

4. A composition according to claim 1, wherein the food grade emulsifier is selected from the group consisting of emulsifiers based on mono- and diglycerides of fatty acids, polyglycerol esters, emulsifiers based on non-glycerol esters of fatty acids and miscellaneous food approved esters.

5. A composition according to claim 1, consisting essentially of about 5% to about 50% by weight of Labiatae herb extract, about 20% to about 70% by weight of food grade emulsifier by weight and about 5% to about 50% by weight of diluent.

6. A composition according to claim 1, consisting essentially of about 5% to about 30% by weight of Labiatae herb extract, about 14% to about 42% by weight of benzyl alcohol by weight, about 14% to about 67% oleyl lactylic acid by weight and 14% to about 42% by weight of propylene glycol.

7. A composition according to claim 6, wherein the Labiatae herb extract is rosemary herb extract.

8. A composition according to claim 6, consisting essentially of about 16% by weight of Labiatae herb extract, about 15% by weight of benzyl alcohol by weight, about 54% oleyl lactylic acid by weight and about 15% by weight of propylene glycol.

9. A composition according to claim 8, wherein the Labiatae herb extract is rosemary herb extract.

10. A composition according to claim 8, wherein the Labiatae herb extract is sage herb extract.

11. A composition consisting essentially of Labiatae herb extract, oleyl lactylic acid and benzyl alcohol which is readily dispersible in cold brine.

12. A composition according to claim 11 that also contains propylene glycol.

13. A composition according to claim 1 that contains adjuvants and vegetable oils.

14. A composition according to claim 1, wherein the viscosity of the composition does not exceed 1000 centipoises at 24.5° C.

15. A stable cold Labiatae herb extract brine dispersion comprising a Labiatae herb extract, a food grade emulsifier or mixture of food grade emulsifiers, a diluent selected from the group consisting of benzyl alcohol, propylene glycol, ethanol and mixtures thereof and a cold brine solution.

16. A stable cold Labiatae herb brine dispersion according to claim 15, wherein the Labiatae herb extract is rosemary extract or sage extract, the food grade emulsifier is oleyl lactylic acid, the diluent is benzyl alcohol and the concentration of the brine solution is 5%.

17. A stable cold Labiatae herb brine dispersion according to claim 15, wherein the Labiatae herb extract is rosemary extract or sage extract, the food grade emulsifier is oleyl lactylic acid, the diluent is propylene glycol and the concentration of the brine is 5%.

18. A stable cold Labiatae herb brine dispersion according to claim 15, wherein the Labiatae herb extract is rosemary extract or sage extract, the food grade emulsifier is oleyl lactylic acid, the diluent is a mixture of benzyl alcohol and propylene glycol and the concentration of the brine is 5%.

19. A method of preparing a stable cold Labiatae herb brine dispersion as defined in claim 15, which comprises mixing a Labiatae herb extract, a food grade emulsifier or a mixture of food grade emulsifiers and a diluent selected from the group consisting of benzyl alcohol, propylene glycol, ethanol and mixtures thereof with cold brine.

20. A method according to claim 19, wherein the Labiatae herb extract is rosemary extract or sage extract, the food grade emulsifier is oleyl lactylic acid and the diluent is benzyl alcohol.

21. A method according to claim 19, wherein the Labiatae herb extract is rosemary extract.

22. A single phase, emulsifiable composition consisting essentially of a Labiatae herb extract, a food grade emulsifier or mixture of food grade emulsifiers, a diluent selected from the group consisting of benzyl alcohol, propylene glycol, ethanol and mixtures thereof, a food enhancer selected from the group consisting of a flavoring agent, an antimicrobial agent and a coloring agent.

23. A composition according to claim 22, wherein the food-flavoring agent is an oleoresin.

24. A composition according to claim 23, wherein the oleoresin is selected from the group consisting of black pepper oleoresin, celery oleoresin, cumin oleoresin and mixtures thereof.

25. A composition according to claim 22, wherein the food-flavoring agent is an essential oil.

26. A composition according to claim 25, wherein the essential oil is selected from the group consisting of onion oil, garlic oil, black pepper oil, celery oil and mixtures thereof.

27. A composition according to claim 22, wherein the antimicrobial agent is selected from the group consisting of lactates, diacetates and an acidulant.

28. A composition according to claim 27, wherein the acidulant is citric acid or ascorbic acid.

29. A composition according to claim 22, wherein the coloring agent is selected from the group consisting of anthocyanin pigments, paprika oleoresin, turmeric extract and caramel colors.

30. A composition according to claim 22, wherein the food flavoring agent is a plant extract.

31. A composition according to claim 30, wherein the plant extract is selected from the group consisting of extracts such as bay extract, black pepper extract, capsicum extract, celery extract, clove extract, cumin extract, garlic extract, onion extract, licorice extract, thyme extract, oregano extract, white pepper extract and mixtures thereof.

32. A composition according to claim 1, wherein the food grade emulsifier is Polysorbate 80.

33. A composition according to claim 1, wherein the food grade emulsifier is oleyl lactylic acid.

34. A composition according to claim 1, wherein the ingredients are those of Example 1.

35. A composition according to claim 1, wherein the ingredients are those of Example 2.

36. A composition according to claim 1, wherein the ingredients are those of Example 3.

37. A composition according to claim 22, wherein the ingredients are those of Example 4.

38. A composition according to claim 22, wherein the ingredients are those of Example 5.

39. A composition according to claim 22, wherein the ingredients are those of Example 6.

40. A composition according to claim 1, wherein the diluent is selected from the group consisting of benzyl alcohol, propylene glycol and mixtures thereof.
